(19) United States
(12) Patent Application Publication
(10) Pub. No.: US 2019/0252721 A1
(43) Pub. Date: Aug. 15, 2019

(54) LITHIUM ION BATTERY

(71) Applicant: KURITA WATER INDUSTRIES LTD., Tokyo (JP)

(72) Inventors: Mitsuru NOZUE, Tokyo (JP); Jun KANEKO, Tokyo (JP)

(21) Appl. No.: 16/317,152

(22) PCT Filed: Jul. 11, 2017
(86) PCT No.: PCT/JP2017/025228

§ 371 Date: Jan. 11, 2019

(30) Foreign Application Priority Data
Jul. 13, 2016 (JP) 2016-138446
Dec. 27, 2016 (JP) 2016-253135

(51) Int. Cl. H01M 10/0567; H01M 10/0525

(52) U.S. Cl. CPC H01M 10/0567; H01M 10/0525

(57) ABSTRACT

A lithium ion battery includes a positive electrode terminal, a negative electrode terminal, and a battery case, which is an airtight container. An electrode body is housed inside the battery case. The electrode body has a positive electrode current collector, a positive-electrode electrode plate, a negative electrode current collector, and a negative-electrode electrode plated. The positive-electrode electrode plate and the negative-electrode electrode plated are laminated via a separator. A hydrofluoric acid absorber is placed in a gap portion in the battery case. This hydrofluoric acid absorber preferably is one having a moisture removal capability, such as zeolite. A lithium ion battery using such a hydrofluoric acid absorber has excellent hydrofluoric acid absorption properties, and in particular can suppress the production per se of hydrofluoric acid.

### TECHNICAL FIELD

The present invention relates to a lithium ion battery used in electronic equipment, automobiles, and the like, and particularly to a lithium ion battery capable of removing hydrofluoric acid produced due to an electrolytic solution.

### BACKGROUND ART

In recent years, large capacity and high-power type lithium ion batteries are being put into practical use. Because such lithium ion batteries have a large capacity and a high power, higher safety and stability than conventional secondary batteries is required.

A representative structure of such a lithium ion battery uses carbon for the negative electrode and a lithium transition metal oxide, such as lithium cobalt oxide, for the positive electrode, and as an electrolytic solution includes a lithium salt, such as lithium hexafluorophosphate (LiPF₆), in an organic solvent such as ethylene carbonate or diethyl carbonate. However, in general, the materials of each of the negative electrode, the positive electrode, and the electrolyte may be any material that allows lithium ions to migrate and charge-discharge to occur by donating and accepting charge. Therefore, a very large number of modes can be employed.

As the lithium salt, in addition to LiPF₆, a fluorine complex salt such as LiBF₄, or a salt such as LiN(SO₂Rf)₂.LiC(SO₂Rf)₃ (Rf═CF₃ or C₂F₅) is used in some cases.

Further, normally, as the organic solvent, to confer higher conductivity and safety to the electrolytic solution, a mixture of a cyclic carbonic acid ester-type high-dielectric-constant and high-boiling-point solvent, such as ethylene carbonate or propylene carbonate, and a low viscosity solvent, such as a lower chain carbonic acid ester such as dimethyl carbonate, ethyl methyl carbonate, or diethyl carbonate is used, and further a lower fatty acid ester may be used in some cases.

Here, a lithium salt such as LiPFE is stable in the battery. However, the lithium salt may leak out of the battery from a pinhole or the like so small that it cannot be found in the inspection process. When the lithium salt leaks in such a way, the lithium salt reacts with the moisture in the air to produce hydrofluoric acid, which is a strong acid, and the produced hydrofluoric acid corrodes the battery case and an explosion-proof valve. Further, even in the process of injecting the electrolytic solution into the battery, the electrolytic solution scatters and hydrofluoric acid is produced, which can also corrode the battery case and the explosion-proof valve. As a result, there has been a problem in that a large amount of electrolytic solution leaks from the corroded explosion-proof valve, causing external circuits to corrode. In order to solve such a problem, Patent Document 1 discloses that a gas absorber is placed outside the explosion-proof valve of the battery main body.

### PRIOR ART DOCUMENT

### Patent Document

[Patent Document 1] JP2011-124256

### SUMMARY OF THE INVENTION

### Problems to be Solved by the Invention

As a result of subsequent research, it was found that a lithium salt such as LiPF₆ may react with a trace amount of moisture in the battery due to repetition of charge-discharge, thereby producing a trace amount of hydrofluoric acid even in the battery, and that this hydrofluoric acid may partially damage the inside of the battery, leading to a decrease in battery performance, such as discharge capacity. However, there is a problem in that the absorber disclosed in Patent Document 1 is for absorbing the hydrogen fluoride gas ejected to the outside of the explosion-proof valve, that is, the produced hydrofluoric acid, and it is not for absorbing the hydrofluoric acid immediately after it is produced.

Therefore, there has been desired a lithium ion battery that uses a hydrofluoric acid absorber capable of suitably absorbing the hydrofluoric acid immediately after it is produced, and in particular, a hydrofluoric acid absorber capable of suppressing the production per se of hydrofluoric acid.

In view of the above problems, it is an object of the present invention to provide a lithium ion battery that uses a hydrofluoric acid absorber having excellent hydrofluoric acid absorption properties, and in particular being capable of suppressing the production per se of hydrofluoric acid.

### Means for Solving the Problems

To solve the above problems, the present invention provides a lithium ion battery comprising a laminated body sealed in a battery case, the laminated body comprising a positive electrode, a negative electrode, and a separator and being impregnated with a non-aqueous electrolytic solution, and lithium ions in the non-aqueous electrolytic solution being responsible for electrical conduction, wherein a hydrofluoric acid absorber capable of absorbing hydrofluoric acid is placed in the battery case (Invention 1).

According to the above invention (Invention 1), by placing a hydrofluoric acid absorber capable of absorbing hydrogen fluoride in the lithium ion battery case, hydrofluoric acid produced inside the case due to repeated charge-discharge and the like can be quickly absorbed immediately after being produced, enabling adverse effects acting on the inside of the battery to be minimized and allowing the lithium ion battery to be kept in a stable state.

In the above invention (Invention 1), it is preferable that the hydrofluoric acid absorber have a moisture removal capability (Invention 2).

According to the above invention (Invention 2), since the hydrofluoric acid absorber absorbs a trace amount of moisture present inside the battery, a reaction between a lithium salt and moisture can be prevented, which enables the production per se of hydrofluoric acid to be suppressed.

In the above inventions (Inventions 1 and 2), it is preferable that the hydrofluoric acid absorber be an inorganic porous material (Invention 3). Further, it is preferable that the hydrofluoric acid absorber be a zeolite (Invention 4). In particular, it is preferable that the hydrofluoric acid absorber be an A-type zeolite ion-exchanged with Ca (Invention 5).

According to the above inventions (Inventions 3 to 5), because these hydrofluoric acid absorbers can quickly absorb hydrogen fluoride and have moisture absorption properties, both capabilities can be exhibited with a single agent.

In the above invention (Invention 1), it is preferable that the hydrofluoric acid absorber be a carbon-based material (Invention 6).

According to the above invention (Invention 6), the carbon-based material can quickly absorb hydrogen fluoride and is excellent in suppressing an increase in the resistance value of the battery.

In the above inventions (Inventions 2 to 6), it is preferable that the hydrofluoric acid absorber have a moisture content adjusted to 1% by weight or less (Invention 7).

According to the above invention (Invention 7), since a dry hydrofluoric acid absorber having a moisture content of 1% by weight or less is placed in the lithium ion battery, the hydrofluoric acid absorber has a high capability of absorbing the trace amount of moisture that is present inside the battery. As a result, a reaction between a lithium salt and the moisture can be suitably prevented and the production per se of hydrofluoric acid can be suppressed.

### Effect of the Invention

According to the present invention, because a hydrofluoric acid absorber capable of absorbing hydrogen fluoride is provided in the lithium ion battery case, hydrofluoric acid (which may be a gas or a liquid (F⁻)) produced inside the case due to repeated charge-discharge and the like can be quickly absorbed immediately after being produced, enabling adverse effects acting on the inside of the battery to be minimized and allowing the lithium ion battery to be kept in a stable state. In particular, using a material having a moisture removal capability, such as zeolite, as the hydrofluoric acid absorber, with the moisture content adjusted to 1% by weight or less, prevents a reaction between a lithium salt and moisture, which enables the production per se of hydrofluoric acid to be suppressed.

### BRIEF DESCRIPTION OF DRAWINGS

FIG. 1 is a cross-sectional view schematically illustrating an internal structure of a lithium ion battery according to an embodiment of the present invention.

FIG. 2 is a graph showing changes in discharge capacity in a charge-discharge cycle test of the lithium ion batteries of Example 1 and Comparative Example 1.

FIG. 3 is a graph showing changes in discharge capacity in a charge-discharge cycle test of the lithium ion batteries of Examples 3 and 4 and Comparative Example 3.

### EMBODIMENTS FOR CARRYING OUT THE INVENTION

Hereinafter, an embodiment of the present invention will be described with reference to the attached drawings.

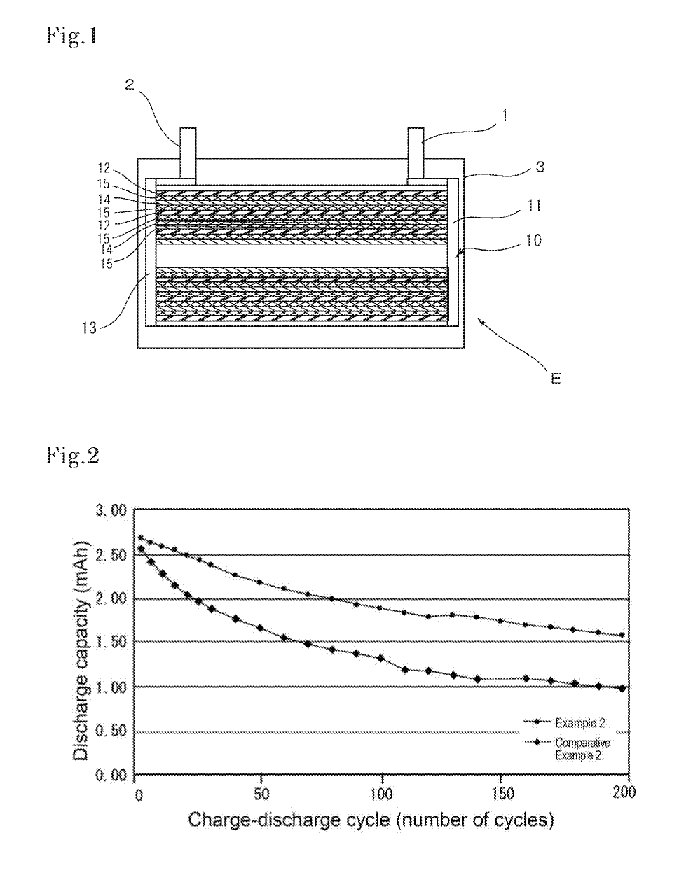

FIG. 1 is a longitudinal cross-sectional view illustrating a lithium ion battery of this embodiment. In FIG. 1, a lithium ion battery E includes a positive electrode terminal 1, a negative electrode terminal 2, a battery case (casing) 3, which is an airtight container, and an explosion-proof valve (not shown) optionally formed on an outer peripheral surface of the battery case 3. An electrode body 10 is housed inside the battery case 3. The electrode body 10 has a positive electrode current collector 11, a positive-electrode electrode plate 12, a negative electrode current collector 13, and a negative-electrode electrode plate 14. The positive-electrode electrode plate 12 and the negative-electrode electrode plate 14 are each laminated via a separator 15. The positive electrode terminal 1 is electrically connected to the positive-electrode electrode plate 12, and the negative electrode terminal 2 is electrically connected to the negative-electrode electrode plate 14. The battery case 3 serving as a casing is, for example, a rectangular battery case can made of aluminum or stainless steel, and is air tight.

The positive-electrode electrode plate 12 is a current collector that has a positive electrode bonding agent on both sides thereof. For example, the current collector is a piece of aluminum foil with a thickness of about 20 μm, and has a paste-like positive electrode bonding agent formed by adding polyvinylidene fluoride as a binding material and acetylene black as a conductive material to lithium cobalt oxide (LiCoO₂), which is a transition metal lithium-containing oxide, and then kneading the resultant mixture. The positive-electrode electrode plate 12 is obtained by coating this paste-like positive electrode bonding agent on both sides of the aluminum foil, then drying, rolling, and cutting into a belt shape.

The negative-electrode electrode plate 14 is a current collector that has a negative electrode bonding agent on both sides thereof. For example, the current collector is a piece of copper foil with a thickness of 10 m, and has a paste-like negative electrode bonding agent formed by adding polyvinylidene fluoride as a binding material to graphite powder and then kneading. The negative-electrode electrode plate 14 is obtained by coating this paste-like negative electrode bonding agent on both sides of the copper foil, then drying, rolling, and cutting into a belt shape.

As the separator 15, a porous film is used. For example, a polyethylene microporous film can be used for the separator 15. The non-aqueous electrolytic solution to be impregnated in the separator is preferably a non-aqueous organic electrolytic solution having lithium ion conductivity. Examples thereof include a mixed solution of a cyclic carbonate, such as propylene carbonate (PC) and ethylene carbonate (EC), and a chain carbonate, such as dimethyl carbonate (DMC), ethyl methyl carbonate (EMC), diethyl carbonate (DEC), and the like. This solution may optionally be a solution in which a lithium salt, such as lithium hexafluorophosphate or the like, is dissolved as an electrolyte. For example, a mixed solution prepared by mixing ethylene carbonate (EC), ethyl methyl carbonate (EMC), and dimethyl carbonate (DMC) in a ratio of 1:1:1, or a mixed solution prepared by mixing propylene carbonate (PC), ethylene carbonate (EC), and diethyl carbonate (DEC) in a ratio of 1:1:1, to which 1 mol/L of lithium hexafluorophosphate has been added, can be used.

A hydrofluoric acid absorber is placed in a gap portion in the battery case 3 of this lithium ion battery E. In the present embodiment, the hydrofluoric acid absorber has a function of adsorbing hydrogen fluoride (HF) produced by a reaction between a lithium salt such as LiPF₆ in the electrolytic solution and moisture in the air. The adsorbed hydrogen fluoride is both gaseous (gas) and a liquid (F⁻).

As the hydrofluoric acid absorber used in this embodiment, an inorganic porous material or a carbon-based material can be suitably used.

As the inorganic porous material, porous silica, a metal porous structure, calcium silicate, magnesium silicate, magnesium aluminometasilicate, zeolite, activated alumina, titanium oxide, apatite, porous glass, magnesium oxide, aluminum silicate and the like can be used.

Further, as the carbon-based material, activated carbon, such as powdered activated carbon, granular activated carbon, fibrous activated carbon, and sheet-like activated carbon, graphite, carbon black, carbon nanotubes, a carbon molecular sieve, fullerene, nanocarbon, and the like can be used. These carbon-based materials can be a material that has been subjected to various kinds of surface treatment for suppressing moisture absorption. The carbon-based material can quickly absorb hydrogen fluoride, and has a particularly excellent effect in suppressing an increase in the resistance value of the battery.

These inorganic porous materials and carbon-based materials may be used alone, or two or more materials may be used in combination. However, zeolite and activated carbon are particularly effective.

The above-mentioned hydrofluoric acid absorber preferably has a specific surface area of 100 to 3000 m²/g. When the specific surface area is less than 100 m²/g, the contact area with hydrogen fluoride and the like is small, and a sufficient adsorption performance cannot be exhibited. On the other hand, it is preferable for the specific surface area not to exceed 3000 m²/g, because when the specific surface area exceeds 3000 m²/g, not only is there no improvement in the adsorption performance of hydrogen fluoride, moisture, and the like, but also the mechanical strength of the absorber deteriorates.

The hydrofluoric acid absorber preferably has a pore size of 3 Å or more and 10 Å or less. When the pore size volume is less than 3 Å, entry of gas components such as hydrogen fluoride and moisture into the pores becomes difficult. On the other hand, it is preferable that the pore size volume does not exceed 10 Å, because when the pore size volume exceeds 10 Å, the adsorptive power of hydrogen fluoride and the like weakens, which prevents the hydrogen fluoride and the like from adsorbing in the densest manner within the pores, resulting in a decrease in the adsorption amount.

Further, when the hydrofluoric acid absorber is a zeolite, it is preferable to use a zeolite having a Si/Al elemental composition ratio in the range of 1 to 5. A zeolite having a Si/Al ratio of less than 1 is structurally unstable, whereas a zeolite having a Si/Al ratio of more than 5 is not preferred because the cation content is low and the adsorption amount of gas components such as hydrogen fluoride and moisture decreases.

As the zeolite, an A-type, X-type or LSX-type zeolite can be used, but in particular, an A-type zeolite or an A-type zeolite in which the cation part of the zeolite has been ion-exchanged with Ca is preferable, and more preferably the zeolite is an A-type zeolite ion-exchanged with Ca.

This hydrofluoric acid absorber preferably has a moisture removal capability. As a result, the hydrofluoric acid absorber can absorb a trace amount of moisture present inside the battery, which enables a reaction between a lithium salt and the moisture to be prevented and production per se of hydrofluoric acid to be suppressed. In this case, an adsorbent having a hydrofluoric acid absorption ability and an adsorbent having a moisture removal capability may be blended together and used, but zeolite is preferable in terms of the point that it has both a hydrofluoric acid absorption ability and a moisture removal ability.

Such an absorber is not only able to absorb hydrofluoric acid, but it is also able to absorb moisture, and tends to absorb moisture in the atmosphere. Further, when this absorber absorbs moisture, not only is its ability to absorb hydrofluoric acid greatly reduced, but its ability to absorb moisture is also reduced. Therefore, in the present embodiment, it is preferable to subject the hydrofluoric acid absorber to a heat treatment to release the moisture from the hydrofluoric acid absorber, and fill the battery case 3 with the hydrofluoric acid absorber in a state in which its ability to absorb moisture has been regenerated. In this case, it is preferable to perform the heat treatment such that the moisture content of the hydrofluoric acid absorber is 1% by weight or less. In addition, the moisture can also be driven from the hydrofluoric acid absorber to achieve a hydrofluoric acid absorber moisture content of 1% by weight or less by thoroughly dehydrating the non-aqueous organic electrolytic solution (which is free from a lithium salt) to be used in the lithium ion battery E and immersing the hydrofluoric acid absorber in that non-aqueous organic electrolytic solution. It is preferable that the moisture content of the hydrofluoric acid absorber does not exceed 1% by weight, because when the moisture content of the hydrofluoric acid absorber exceeds 1% by weight, the absorption properties of the moisture in the atmosphere become insufficient, the effect of preventing a reaction between a lithium salt and the moisture decreases, and battery performance tends to deteriorate.

The form of the hydrofluoric acid absorber as described above is not particularly limited, and is preferably in the form of a powder, granules, or pellets, and even a hydrofluoric acid absorber molded into a sheet or film form by mixing with a resin may be used.

Although the present invention has been described with reference to the accompanying drawings, the present invention is not limited to the above-described embodiments and various modifications can be made thereto. For example, the lithium ion battery E is not limited, and it may be cylindrical. Moreover, the lithium ion battery may be housed in a battery case capable of separately housing the battery, and the hydrofluoric acid absorber may be provided in that battery case.

### EXAMPLES

The present invention is now described in more detail based on the following specific examples, but the present invention is not limited to the following examples.

### [Test for Confirming HF Removal Effect]

### Example 1

In a 100 mL vial bottle, as a hydrofluoric acid adsorbent, 1 g of an A-type zeolite exchanged with Ca having a moisture content adjusted in advance to 1% by weight or less was portioned out, then under a nitrogen atmosphere 50 mL of a commercially available electrolytic solution (electrolytic solution (ethylene carbonate (EC):dimethyl carbonate (DMC):ethyl methyl carbonate (EMC) mixed in a volume ratio of 2:4:4) in which 1 mol/L of LiPF₆ had been dissolved) was injected, and 5 μL of pure water was added dropwise.

The results of measuring the fluoride ion (F⁻) concentration of this electrolytic solution after a predetermined time had elapsed are shown in Table 1. As a reference example, the measurement results of the fluoride ion (F⁻) concentration for only the electrolytic solution are also shown in Table 1.

### Comparative Example 1

The fluoride ion (F⁻) concentration of the electrolytic solution was measured in the same manner as in Example 1, except that a hydrofluoric acid adsorbent was not used. The results are also shown in Table 1.

TABLE 1

| | | F⁻ Concentration |
|---|---|---|
| Example No. | Sample Composition | (mg/L) |
| Example 1 | Electrolytic solution + pure water + | <10* |
| | hydrofluoric acid adsorbent | |
| Comparative | Electrolytic solution + pure water | 120 |
| Example 1 | | |
| Reference | Electrolytic solution only | 40 |
| Example | | |

*Less than the detection lower limit value (10 mg/L)

As can be seen from Table 1, in Comparative Example 1, in which pure water was added to the electrolytic solution, the fluoride ion concentration was significantly higher than in the reference example, which used only the electrolytic solution. This is considered to be due to the production of hydrofluoric acid from a reaction between the LiPF₆ and the moisture. In contrast, in Example 1, in which the hydrofluoric acid adsorbent of the present invention was added, the fluoride ion concentration was less than the detection lower limit value, and was lower than that of the reference example. This is considered to be because the hydrofluoric acid adsorbent not only removes hydrofluoric acid, but it also has a moisture removal capability, and hence the production per se of hydrofluoric acid is suppressed.

### [Charge-Discharge Cycle Test]

### Example 2

The following materials were prepared as the materials for a test lithium ion battery.

Flat cell: Manufactured by Hohsen Corp., electrode area of about 2 cm² (Φ16 mm)
Positive electrode: Ternary (LiNiCoMnO₂), N:M:C=1:1:1
Negative electrode: Spheroidal graphite
Separator: PP separator, thickness of 20 μm
Electrolytic solution: 1 mol/L solution in which LiPF₆ was dissolved in a mixed solution of ethylene carbonate (EC):ethyl methyl carbonate (EMC)=3:7
Hydrofluoric acid adsorbent: Ca-exchanged A-type zeolite (adjusted to a moisture content of 1% by weight or less)

The hydrofluoric acid adsorbent was charged into the electrolytic solution at a rate of 0.02 g/mL, while the positive electrode, negative electrode and separator were dried under reduced pressure at 90° C. for 1 hour or more using a glass tube oven. Then, these materials were assembled at a dew point of −30° C. or less in an argon gas atmosphere in a glove box to prepare a lithium ion battery material for testing.

The lithium ion battery was connected to a charge-discharge test unit (Charge-Discharge Battery Test System PFX2011, manufactured by Kikusui Electronics Corporation). A charge-discharge cycle was repeated 200 times under a charge-discharge amperage of 0.5 C, a constant-voltage charge of 4.2 V×60 minutes, and a discharge cut-off voltage of 3.2 V, and changes in the discharge capacity were measured. The results are shown in FIG. 2.

### Comparative Example 2

The lithium ion battery materials for testing were prepared in the same manner as in Example 2, except that the hydrofluoric acid adsorbent was not added to the electrolytic solution.

The lithium ion battery was connected to the charge-discharge test unit, the charge-discharge test was carried out under the same conditions as in Example 2, and changes in the discharge capacity were measured. The results are also shown in FIG. 2.

As is clear from FIG. 2, in Example 2, in which the hydrofluoric acid adsorbent was used, the discharge capacity decreased by only about 40% even when charge-discharge was repeated 200 times, whereas in Comparative Example 2, in which the hydrofluoric acid adsorbent was not used, the discharge capacity decreased to 60% or less. It is thought that this was due to partial degradation occurring inside the battery from the hydrofluoric acid produced in the battery, causing the battery performance to decline.

### Example 3

A positive electrode was prepared by adding 5% by weight of a porous carbon material (Epsiguard KC-601P, manufactured by Kurita Water Industries Ltd., average particle size of 2.5 μm) to 100% by weight of an LCO-based electrode material (positive electrode active material:carbon black (KB):polyvinylidene fluoride (PVDF)=92:4:4 (weight ratio)). Further, a negative electrode was prepared from a natural graphite-based material. An aluminum laminate cell having a capacity of about 900 mAh was then prepared using the positive electrode and negative electrode. As the electrolytic solution, a solution obtained by dissolving 1 mol/L of LiPF₆ in a mixed solution of ethylene carbonate (EC):ethyl methyl carbonate (EMC)=3:7 was used.

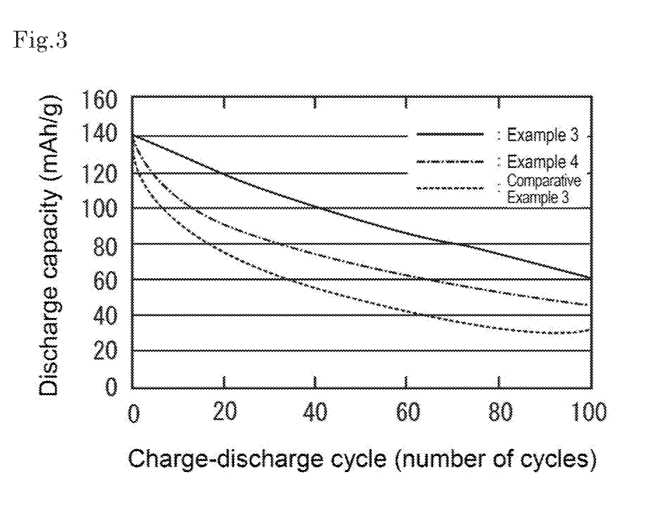

The lithium ion battery was connected to a charge-discharge test unit (Charge-Discharge Battery Test System PFX2011, manufactured by Kikusui Electronics Corporation). A charge-discharge cycle test was carried out 100 cycles at 60° C., and the discharge capacity during this time was recorded. In this cycle test, charging was carried out at a charge amperage of 1 C with a constant current/constant voltage, and was carried out to 0.05 C after the voltage had reached 4.2 V. Discharge was carried out at 1.0 C with a constant current until the voltage reached 2.5 V. The results are shown in FIG. 3. Further, the DC resistance value of the lithium ion battery after the 100-cycle charge-discharge cycle test was measured and compared with the DC resistance value immediately after activation by the initial charge. The results are shown in Table 2. In addition, the electrolytic solution was extracted from the inside of the cell after the end of 100 cycles, and the fluoride ion (F⁻) concentration (corresponding to hydrofluoric acid (HF)) of this electrolytic solution was measured. Those results are shown in Table 3.

### Example 4

An aluminum laminate cell having a capacity of about 900 mAh was prepared in the same manner as in Example 3, except that the positive electrode was prepared by adding 2% by weight of a porous carbon material (Epsiguard KC-601P, manufactured by Kurita Water Industries Ltd., average particle size of 2.5 μm) to 100% by weight of an LCO-based electrode material.

The lithium ion battery was connected to the charge-discharge test unit. A charge-discharge cycle test was carried out 100 cycles at 60° C. in the same manner as in Example 3, and the discharge capacity during this time was recorded. The results are shown in FIG. 3. The DC resistance value of the lithium ion battery after the 100-cycle charge-discharge cycle test was measured and compared with the DC resistance value immediately after activation by the initial charge. The results are shown in Table 2.

### Comparative Example 3

An aluminum laminate cell having a capacity of about 900 mAh was prepared in the same manner as in Example 3, except that a porous carbon material (Epsiguard KC-601P, manufactured by Kurita Water Industries Ltd., average particle size of 2.5 μm) was not added to 100% by weight of an LCO-based electrode material.

The lithium ion battery was connected to the charge-discharge test unit. A charge-discharge cycle test was carried out 100 cycles at 60° C. in the same manner as in Example 3, and the discharge capacity during this time was recorded. The results are shown in FIG. 3. The DC resistance value of the lithium ion battery after the 100-cycle charge-discharge cycle test was measured and compared with the DC resistance value immediately after activation by the initial charge. The results are shown in Table 2. In addition, the electrolytic solution was extracted from the inside of the cell after the end of 100 cycles, and the fluoride ion (F⁻) concentration (corresponding to hydrofluoric acid (HF)) of this electrolytic solution was measured. Those results are shown in Table 3.

TABLE 2

| | Initial DC | DC resistance value after |
|---|---|---|
| Example No. | resistance value | end of 100 cycles |
| Example 3 | 55 mΩ | 223 mΩ |
| Example 4 | 89 mΩ | 748 mΩ |
| Comparative | 100 mΩ | 902 mΩ |
| Example 3 | | |

TABLE 3

| Example No. | F⁻ Concentration (mg/L) |
|---|---|
| Example 3 | 28 |
| Comparative | 46 |
| Example 3 | |

As is clear from FIG. 3, in Example 3, in which 5% by weight of a porous carbon material was added as a hydrofluoric acid adsorbent in the positive electrode, the number of cycles until the discharge capacity reached 100 mAh/g, which is a decrease of about 30% from the initial discharge capacity, was about 5 times that of Comparative Example 3, and even in Example 4, in which 2% by weight was added in the positive electrode, the number of cycles until the discharge capacity reached 100 mAh/g, which is a decrease of about 30% from the initial capacity, was about twice that of Comparative Example 3, from which it can be seen that that battery performance can be maintained for a long period of time. Further, from Tables 2 and 3, it can be seen that adding a porous carbon material as a hydrofluoric acid adsorbent to the positive electrode suppresses production of hydrofluoric acid, thereby suppressing an increase in battery resistance and prolonging battery life.

### DESCRIPTION OF REFERENCE NUMERALS

1 Positive electrode terminal
2 Negative electrode terminal
3 Battery case (casing)
10 Electrode body
11 Positive electrode current collector
12 Positive-electrode electrode plate
13 Negative electrode current collector
14 Negative-electrode electrode plate
15 Separator
E Lithium ion battery

1. A lithium ion battery comprising a laminated body sealed in a battery case, the laminated body comprising a positive electrode, a negative electrode, and a separator and being impregnated with a non-aqueous electrolytic solution and lithium ions in the non-aqueous electrolytic solution being responsible for electrical conduction, wherein a hydrofluoric acid absorber capable of absorbing hydrofluoric acid is placed in the battery case.

2. The lithium ion battery as recited in claim 1, wherein the hydrofluoric acid absorber has a moisture removal capability.

3. The lithium ion battery as recited in claim 1, wherein the hydrofluoric acid absorber is an inorganic porous material.

4. The lithium ion battery as recited in claim 3, wherein the hydrofluoric acid absorber is a zeolite.

5. The lithium ion battery as recited in claim 4, wherein the hydrofluoric acid absorber is an A-type zeolite ion-exchanged with Ca.

6. The lithium ion battery as recited in claim 1, wherein the hydrofluoric acid absorber is a carbon-based material.

7. The lithium ion battery as recited in claim 2, wherein the hydrofluoric acid absorber has a moisture content adjusted to 1% by weight or less.
